(19) United States
(12) Patent Application Publication
(10) Pub. No.: US 2002/0094414 A1
(43) Pub. Date: Jul. 18, 2002

(54) Composite structural article having a low internal stress

(76) Inventors: Joachim Wagenblast, Hong Kong (CN); Hubert Goldbach, Ratingen (DE)

Correspondence Address: BAYER CORPORATION, PATENT DEPARTMENT, 100 BAYER ROAD, PITTSBURGH, PA, 15205, US

(21) Appl. No.: 10/047,364

(22) Filed: Jan. 14, 2002

(30) Foreign Application Priority Data
Jan. 17, 2001 (DE) 10101772.3

(51) Int. Cl. B32B 3/10

(52) U.S. Cl. 428/139

(57) ABSTRACT

A composite structural article is described. The composite structural article comprises: (a) a core body fabricated from a high-strength material, said core body having a plurality of perforations; and (b) a plastics part of thermoplastic material abutting at least a portion of a surface of said core body. The core body (a) is joined to said plastics part (b) by means of joining elements which extend through at least some of the perforations in the core sheet. The joining elements form an interlocking engagement between the core body and the plastics part that is perpendicular to the plane of the core body. The joining elements and perforations are mutually dimensioned to allow reversible frictional movement between the core body and the plastics part along at least one of the x and y direction of the plane of each of the core body and the plastics part.

### CROSS REFERENCE TO RELATED PATENT APPLICATION

The present patent application claims the right of priority under 35 U.S.C. 119 (a)-(d) of German Patent Application No. 101 01 772.3, filed Jan. 7, 2001.

### DESCRIPTION OF THE INVENTION

The present invention relates to a composite structural article having a low internal stress that is fabricated at least from a core body consisting of a high-strength material and a plastics part of thermoplastic material abutting at least a portion of the surface of the core body, the core body being joined at discrete joining sites to the plastics part. Stresses due for example to different thermal expansions of the materials of the core body and plastics part are minimized or eliminated by means of specially configured joining elements therebetween.

The composite article includes components of different materials assembled using interlocking joining elements, the interlocking engagement permitting a relative movement of the different components with at least one degree of freedom.

The invention relates in particular to plastics-metal hybrid structural parts with interlocking joining elements that minimize or prevent the buildup of internal stresses in the structural article resulting from different thermal expansion of the various materials.

The composite structural article comprises a hybrid structural part that is composed of a plurality of components of different materials such as for example plastics and metal. The various components are joined by means of specific joining elements that are designed to effect interlocking engagement with respect to at most two spatial directions.

Plastics/metal composite structural parts in which metal sheets are supported by rib structures of thermoplastic materials, e.g., polyamide, are found in practice (see for example EP 370 342 A2, EP 995 068 A2). In this connection the rib structure is fixed securely to the metal sheet in an interlocking manner in all three spatial directions.

These conventionally used composite structural parts have the disadvantage that they exhibit a high internal stress state on account of their production by means of injection molding. The thermoplastic component is sprayed or injected in the form of a melt onto the metal sheet acting as a core body and then cooled. Due to the marked shrinkage of the thermoplastic material during the cooling process, stresses are induced in the structural part that can be only partially dissipated through relaxation processes in the thermoplastic component. The different thermal expansions of the various components of the structural part can moreover even intensify these stresses during use. For this reason only partially crystalline thermoplastic materials are used for this type of composite structural parts. Up to now only applications using polyamide have been known. This thermoplastic material produces a natural, relatively marked absorption of moisture, which together with an expansion of the material helps to reduce stresses. Amorphous thermoplastic materials on the other hand are unsuitable for such composite structures since they fail due to stress crack corrosion.

The object of the present invention is accordingly to provide composite structural parts of the type mentioned in the introduction that prevent, due to relative movements between the components, i.e., core body and plastics part, the build-up of internal stresses.

This object is achieved according to the invention by a structural part with interlocking joining elements, in which the interlocking engagement is cancelled in at least one direction and is replaced by a frictional engagement (or force closure).

In accordance with the present invention, there is provided a composite structural article comprising:

(a) a core body fabricated from a high-strength material, said core body having a plurality of perforations; and

(b) a plastics part of thermoplastic material abutting at least a portion of a surface of said core body,

wherein said core body is joined to said plastics part by means of joining elements which extend through at least some of said perforations, said joining elements forming an interlocking engagement between said core body and said plastics part that is perpendicular to the plane of said core body, said joining elements and said perforations being mutually dimensioned or sized to allow reversible frictional movement between said core body and said plastics part along at least one of the x and y direction of the plane of each of said core body and said plastics part.

As used herein and in the claims, the term “mutually dimensioned” refers to the perforations of the core body having a larger dimension in at least one of the x and y directions than at least one of the x and y dimensions of the joining elements extending therethrough, such that reversible frictional movement between the core body (a) and the plastics part (b) along at least one of the x and y direction of the plane of each of the core body and the plastics part is allowed to occur.

The features that characterize the present invention are pointed out with particularity in the claims, which are annexed to and form a part of this disclosure. These and other features of the invention, its operating advantages and the specific objects obtained by its use will be more fully understood from the following detailed description and the accompanying drawings in which preferred embodiments of the invention are illustrated and described.

Other than in the operating examples, or where otherwise indicated, all numbers or expressions, such a those expressing structural dimensions, injection conditions, etc, used in the specification and claims are to be under stood as modified in all instance by the term “about.”

### BRIEF DESCRIPTION OF THE DRAWINGS

FIG. 1 is a representative perspective view of a structural article according to the invention;

FIG. 2 is a sectional representation along line A-A of FIG. 1;

FIG. 3 is a sectional representation along line B-B of FIG. 1;

FIG. 4 is a representative bottom-up plan view of a composite structural article according to the present invention with rivet pegs;

FIG. 5 is a sectional representation along line C-C of the composite structural article of FIG. 4;

FIG. 6 is a representative top-down plan view of the composite structural article of FIG. 4;

FIG. 7 is a sectional representation along line C-C of the composite structural article of FIG. 8;

FIG. 8 is a representative plan view of a composite structural article according to the present invention wherein the plastics part forms a rib structure having a plurality of intersecting ribs; and

FIG. 9 is a representative perspective view of a composite structural article according to the present invention in the form of a splash board for a vehicle.

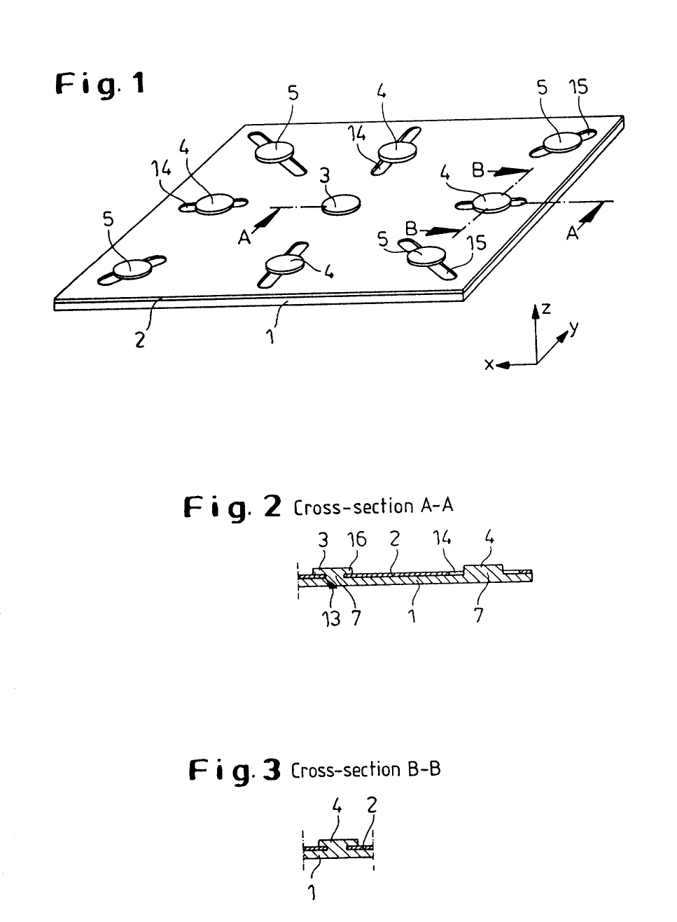

Unless otherwise noted, in FIGS. 1 through 9, like reference numerals and characters designate the same components and structural features.

### DETAILED DESCRIPTION OF THE INVENTION

Preferably the perforations of the core body are in the form of elongated holes, which allow for a principal expansion of the plastics part (b) relative to the core body (a) along the longitudinal axis of the elongated holes.

In a particularly preferred embodiment of the present invention, the perforations in the plane of the core body have a larger dimension in both the x and y directions than the respective joining elements (e.g., plastic pegs or rivets) of the plastics part that penetrates the perforations.

In a further preferred embodiment of the present invention, the plastics part (b) forms a rib structure having a plurality of intersecting ribs, the joining elements and joining sites of the plastics part being arranged predominantly at the points of intersection of the ribs.

The present invention also provides for the use of the composite structural part according to the invention as a construction element for machinery and vehicles, in particular for motor vehicles, for electronics parts, domestic appliances or the building and construction sector.

The high-strength materials for the core body (a) may be of steel, aluminum, magnesium, ceramics, thermosetting materials, fiber reinforced thermoplastics or composites of these materials.

The thermoplastic material of the plastics part (b) may be an unreinforced, reinforced or filled thermoplastic material selected from at least one of polyamide, polyester, polyolefin, styrene copolymer, polycarbonate, polyphenylene oxide, polyphenylene sulfide, polyimide, polyvinyl chloride, polyurethane, PSO and PEEK.

The core body (a) and plastics part (b) may each independently be present in the form of sheets, boards, plates, profiled sections (open and closed profiled sections) and hollow cavities. The type of material, and number and form of the components may be varied. In a preferred embodiment two-dimensional parts and/or components, such as for example metal sheets, are provided with a rib structure or a cover sheet of plastics material. To this end rivets are formed on the joining element (e.g., a thermoplastic joining element) that form, perpendicular to the principal expansion direction(s) of the plastics part (b) (in the case of two-dimensional structural parts expansion directions in the two-dimensional plane), an interlocking connection and, parallel to the principal expansion direction(s), a frictional type connection to the high-strength component (a). In this embodiment it is important whether rod-shaped or two-dimensional structural parts are involved. Rod-shaped structural articles will expand predominantly only in the longitudinal direction, whereas in the case of two-dimensional structural parts two expansion directions have to be taken into account in the corner regions.

In this way a plurality of core bodies may also be directly joined to one another. In this case the function of the plastics material may be restricted to holding the core bodies together in the form of rivets. The core bodies may also be joined in an interlocking manner in the principal expansion direction(s) of the thermoplastic component. Due to the interlocking engagements, forces may be transmitted directly from one core body to another. The plastic rivets simply hold the composite bodies together and secure the material composite structure. The rivets are designed for allowing frictional engagement in the principal expansion directions and for interlocking engagement perpendicular to the expansion direction(s).

The possibility also exists of providing a structural article that comprises of a plurality of high-strength components directly joined to one another and that are likewise secured by means of plastics rivets, the plastics component, however also further performing other tasks, for example in the form of an integral plate or sheet.

The scope of the present invention also encompasses a composite structural article which further comprises at least one fixed joining element that provides no reversible frictional movement between the core body (a) and the plastics part (b) along the x and y directions of the plane of each of the core body and the plastics part. Fixed joining elements form a substantially nonreversible interlocking engagement between the core body (a) and the plastics part (b) in all three coordinate directions (i.e., in the x, y and z coordinates) relative to the plane of the core body.

The production of the composite structural article of the present invention may be achieved in various ways. In this regard there is more than one means by which the core body (a) and the plastics part (b) may be joined, as described further herein.

1. Joining by Injection Molding:

In this production process the core body (a) is provided with perforations (for example metal sheet with pockets), through which a joining element forming an interlocking connection perpendicular to the principal expansion directions is effected with the plastics part (b).

In joining by means of injection molding, a core body (a) in the form of a metal sheet for example, is first placed in an injection molding tool. The injection molding tool is then closed and the plastics material is injected. Since the plastics material is injected in liquid or molten form into the injection molding tool, it can flow through the perforations in the metal sheet and form a rivet shaft therethrough and a rivet head on the rear or other side. In order to prevent an interlocking engagement also occurring in the principal expansion direction(s) of the plastics component, the injection molding tool is typically provided with cores. These cores are arranged so that, within the pockets of the core body (a), recesses are formed between the core body (a) and rivet that permit a relative movement between the plastics part (b) and core body (a) in the principal expansion direction or directions. The removable cores prevent at least a portion of the edges of the perforations from being embedded in the thermoplastic material injected and extending therethrough.

By way of example, a joining element may be mentioned here that permits a relative movement in one direction (i.e., in the x or y direction). In this regard, the core body sheet (a) is typically provided with an elongated hole. In the injection molding process the spaces on the left and right sides of the elongated hole are then filled by removable cores, so that a rivet peg or shaft can be formed as a constituent of the plastics rivet primarily in the middle of the elongated hole. The cores preventing the edges of the elongated hole from becoming embedded in the thermoplastic material of the rivet shaft. This rivet shaft can then be displaced to the left and right edge of the elongated hole during relative movements between the core body sheet (a) and plastics part (b).

By means of injection molding, various metal or composite material parts can also be joined directly or indirectly in one process step via regions of thermoplastic material. Furthermore, by means of the injection molding process a thermoplastic component (b) of the hybrid structural part to be produced can be formed for example in the shape of a plate, as well as concurrently joined to the metal sheet.

2. Joining by Plastics Rivets Formed After Molding:

Joining of the plastics part (b) to the high-strength component core body (a) can also be achieved by using a plastics rivet. In this case the thermoplastic component is first injected separately without the metal sheet, but with a plurality of connecting pegs or shafts formed thereon. The metal sheet or sheets are then placed on the plastics part so that the connecting shafts penetrate the perforations of the metal sheet or sheets.

The perforations and rivet shafts are mutually dimensioned to have space therebetween which allows execution of frictional movement in the necessary directions between the core body (a) and the plastics part (b). The connecting rivet shafts are then formed into a rivet head by means of a forming process (for example ultrasound welding). In addition a weld joint can be produced using separate alloying elements (e.g. peg welding) by means of friction welding or possibly by ultrasound welding or even by joining two thermoplastic components (sheets, profiled sections, etc.) with joining elements formed thereon.

3. Interlocking Joining of the Plastics Part (b) to the Core Body (a) by Insertion, Snap Fit or Screws:

In this process a plastics part (b) that is provided with the necessary insertion, snap fit or screw elements is first produced. For this purpose an injection molded plastics part may for example be used, having rivets or screw caps formed thereon that are inserted into free perforations (elongated hole or square recesses) in the core body (a). The matching counterpart is then snap fitted or screwed on, thereby producing the interlocking engagement.

4. Combinations of Different Means for Joining the Core Body (a) to the Plastics Part (b):

Further possible ways of joining the components of the composite structural article include the use of different combinations of processes 1, 2 and 3, as described previously herein. Consequently there is also the possibility of producing interlocking connections between the high-strength core body (e.g., high-strength sheets) by providing congruent beading in both parts. Rivet joints between the plastics part (b) and metal sheets (a) are inserted over additional congruent free perforations. In this way an interlocking joining of the sheets as well as a friction-type joining of the sheets (a) and the plastics part (b) is achieved in the principal expansion directions.

In all joining processes a plurality of high-strength components (a), e.g., sheets, can also be joined to one another.

Advantages of the composite structural articles of the present invention include the following. The present invention allows for the fabrication of composite structural articles of materials having different material behavior, having in particular different thermal expansions, in a state substantially free of internal stress. The present invention provides for the possibility of using amorphous plastics materials sensitive to stress cracking for large two-dimensional plastics/metal composite structural articles. The present invention provides cost-optimized and weight-optimized composite structural articles that may be prepared from inexpensive and/or low density plastic materials. The present invention allows for a wide choice of the joining processes for connection with other structural articles. The composite structural articles of the present invention may be prepared in a single process stage.

The invention is illustrated in more detail hereinafter with reference to drawing FIGS. 1 through 9, without however the invention being limited to the details thereof.

### EXAMPLES

Two-dimensional composite articles comprising a plastics part (b) in the form of a plate and core body (a) in the form of a metal sheet, are described with reference to FIGS. 1-3.

### Example 1

FIG. 1 shows a plastics part (b) in the form of a plate 1 of a thermoplastics material (polyamide) that is secured at various points by interlocking-type joining elements 3, 4 and 5 to a core body (b) in the form of a metal sheet 2. In FIG. 1 the joining element 3 in the middle of the plate composite forms a fixed rivet joint having no (or zero) degrees of freedom. The joining elements 4 are located between each pair of comers at the edge of the plate composite. Due to the elongated hole 14 in the metal sheet 2 this rivet joint is able to expand, depending on its position, in the x or y direction. The joining elements 5 are located in the corners of the plate composite and can move in both co-ordinate directions (i.e., in both the x and y directions) in the plane of the plate due to the diagonal alignment of the elongated holes 15 in the metal sheet 2.

The composite structural article may be produced in various ways. If the plastics plate 1 is prepared by injection molding, then the plastics plate 1 can be injected directly onto the metal sheet 2. In this case the rivet joints 3, 4 and 5 are at the same time formed thereon. It should be noted that joining elements 4 and 5 can move reversibly in the corresponding directions by means of pockets in the shape of the open positions of the elongated holes 14 and 15. These pockets are formed by removable cores in the injection molding tool that penetrate and occlude the perforations 14 and 15 of the metal sheet 2, during the injection molding process.

It is also possible first of all to produce the plastics plate 1 separately, and then join it to the metal sheet 2. If the plastics plate 1 is produced similarly by injection molding, pegs or shafts for rivet joints 3, 4 and 5 or screw caps for screw connections are integrally formed thereon. If the plastics plate 1 is to be removed from a semi-finished product, then the joining elements are typically attached subsequently by welding, bonding, screwing, metal rivets and/or clinches. The joining elements are then inserted through the perforations of the sheet 2, and the metal sheet 2 is clamped to the plastics plate 1 by the corresponding counterpart of the joining element.

FIG. 2 is a sectional representation along line A-A of FIG. 1. The section between the joining element 3 from the middle and the joining element 4 from the edge region between two corners of the composite plate of FIG. 1 can be recognized. In the case of joining element 3, the circular bore 13 in the metal sheet 2 is completely filled by the rivet shaft 7 in which the edges of bore 13 are embedded, with the result being that no relative movement is possible between the metal sheet 2 and plastics plate 1 at this particular location. Such relative movement is not necessary in the middle of a perforated-symmetrical plate. In the z direction, the joining element 3 is secured by the rivet head 16. The joining element 4 permits within the elongated hole 14 that is formed in the metal sheet 2, a movement of the rivet shaft 7 relative to the metal sheet 2 in the x direction.

FIG. 3 is a section along line B-B through the joining element 4 on the right-hand side of the composite plate according to FIG. 1. The section through the joining element 4 transverse to the expansion direction, which runs in the x direction, is shown. The rivet shaft 7 produces an interlocking engagement between the metal sheet 2 and plastics plate 1 in the y direction, and the rivet head 16 produces a similar engagement in the z direction.

### Example 2

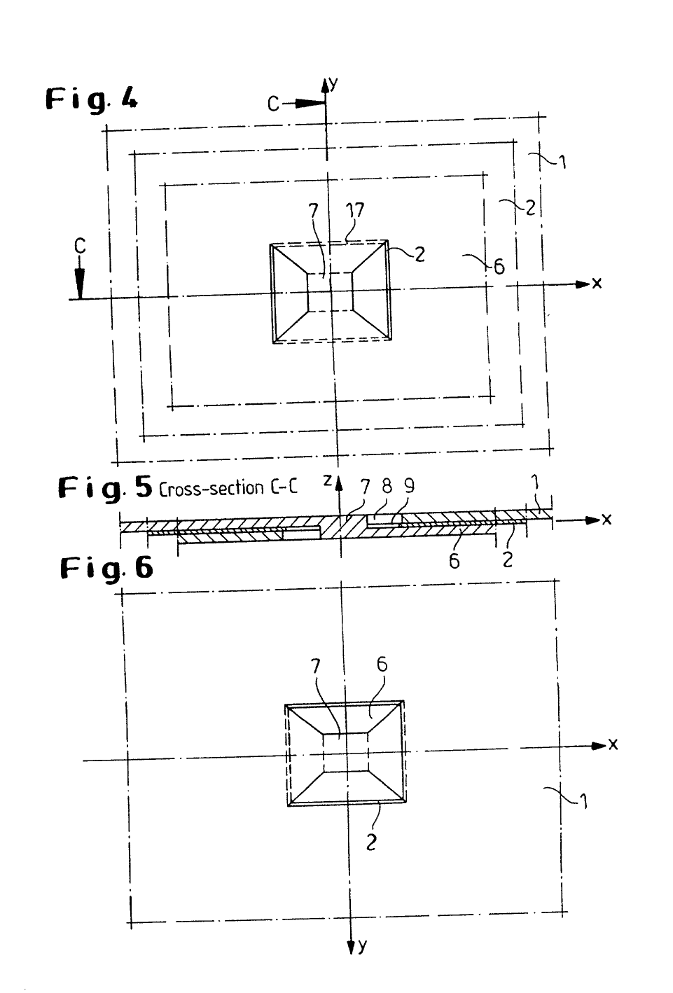

Interlocking joining elements have two degrees of freedom are described with reference to FIGS. 4-6.

FIGS. 4 to 6 show different views of a joining element having two degrees of freedom in the two-dimensional plane. FIG. 4 is a plan view from below. The section of a plastics plate 1 that is joined via the illustrated joining element (FIGS. 4-6) to a section of the plastics plate 6 can be seen. A section of the metal sheet 2 is arranged therebetween. The arrangement of the plastics plate 1, metal sheet 2 and plastics plate 6 can furthermore be seen in FIG. 5. FIG. 5 shows a cross-section of the joining element along the section line C-C shown in FIG. 4. FIG. 6 is a plan view from above.

The joining of the three components, namely plastics plates 1 and 6 as well as the metal sheet 2, is effected by means of the rivet shaft 7, which is fixedly connected to the plastics plate 1 as well as to the plastics plate 6. The rivet shaft 7 can move in the two-dimensional plane relative to the metal sheet 2 over the pocket 9 shaped as a square annular gap of rectangular cross-section formed by the arrangement of the rivet shaft 7 and the square pocket 17 in the metal sheet 2. In order to produce the pocket 9, for manufacturing reasons pockets 8 are formed in the plastics plates 1 and 6. By means of the arrangement of the pockets 8 according to FIGS. 4 to 6, account is taken of the fact that the rivet shaft 7 has to be fixedly connected to the plastics plates 1 and 6 in order to produce an interlocking engagement in the z direction. Accordingly the pockets 8 are formed in the x direction in the plastics plate 6 and in the y direction in the plastics plate 1. Another arrangement (for example pockets 8 in the x direction in the plastics plate 1 and in the y direction in the plastics plate 6, or overlapping pockets) is also possible.

### Example 3

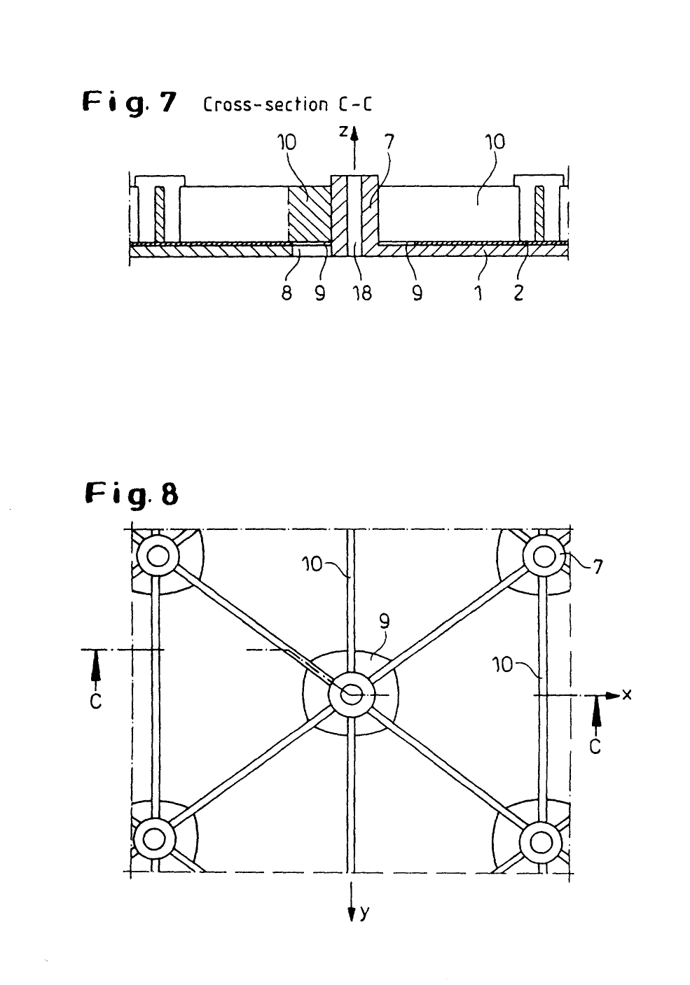

A composite structural article comprising a metal sheet (a) and rib structure (b) of plastics material with joining elements having two degrees of freedom is described with reference to FIGS. 7 and 8.

A metal sheet 2 is shown that, as represented in FIG. 7, is covered on its lower surface with a plastics plate 1, and is supported on the upper surface by a rib structure 10. A plan view of the composite section from above is shown in FIG. 8.

The joining of the three components, namely the plastics plate 1, the metal sheet 2 and the rib structure 10 of thermoplastics material is effected by means of the rivet shafts 7 having a central bore 18, which are fixedly connected to the plastics plate 1 and rib structure 10. The rivet shafts 7 are joined to one another via the individual ribs 10 to form an interlocking engagement in the z direction. Due to the pocket 9 the rivet shafts 7 can move in the two-dimensional plane relative to the metal sheet 2. Under the ribs 10 the region of the pocket 9 is arranged over the pockets 8.

The composite structural article may be produced by means of an injection molding process. In the injection molding process, a metal sheet 2 is first placed in an injection molding tool and the thermoplastics component used to form the plastics plate 1, the rib structure 10 and rib pegs 7 is then injected onto the sheet 2.

### Example 4

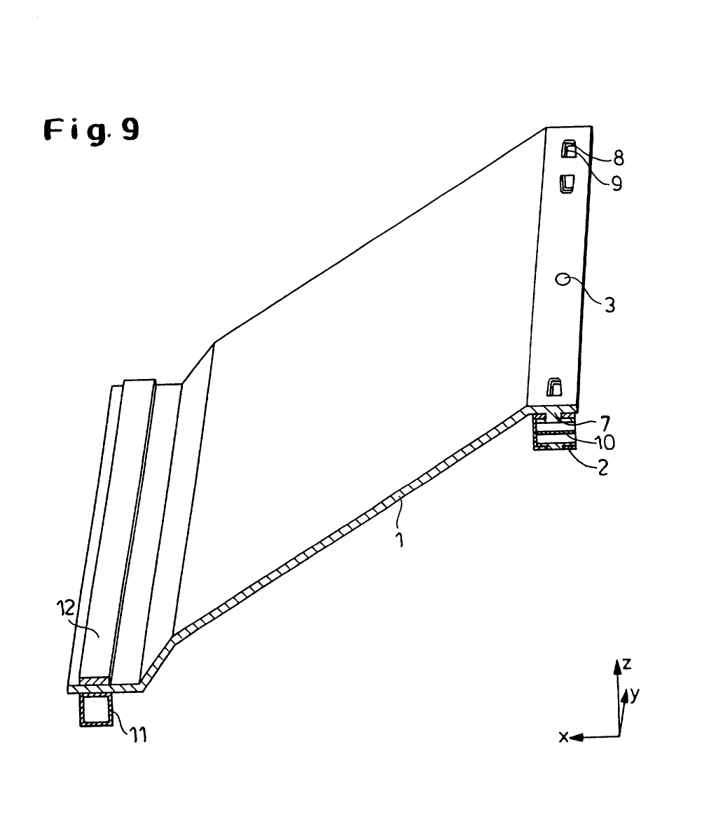

A splash board between two transverse supports of a vehicle is described with reference to FIG. 9.

FIG. 9 represents the arrangement of a plastics plate 1 as a splash board between the transverse supports 2 and 11. The transverse support 2 consists of a U-shaped steel sheet that is supported by a rib structure 10 of thermoplastics material. The rib structure 10 is joined to the plastics plate 1 and the transverse support 2 via rivet shafts 7. By means of the pockets 9 that are arranged over the pockets 8, the rivet shafts 7 can be moved in the longitudinal direction of the transverse support 2 (y direction) relative to the metal sheet of the transverse support 2. The transverse support 2 and the plastics plate 1 are joined without any degree of freedom in an interlocking manner in all three spatial planes via the joining element 3 that is arranged in the middle of the transverse support 2. Longitudinal changes in the plastics plate 1 in the x direction due to temperature can be compensated by the frictional clamping of the plastics plate 1 between the transverse support 11 and butt plate 12.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A composite structural article comprising:
(a) a core body fabricated from a high-strength material, said core body having a plurality of perforations; and
(b) a plastics part of thermoplastic material abutting at least a portion of a surface of said core body,
wherein said core body is joined to said plastics part by means of joining elements which extend through at least some of said perforations, said joining elements forming an interlocking engagement between said core body and said plastics part that is perpendicular to the plane of said core body, said joining elements and said perforations being mutually dimensioned to allow reversible frictional movement between said core body and said plastics part along at least one of the x and y direction of the plane of each of said core body and said plastics part.

2. The composite structural article of claim 1 wherein said perforations are elongated holes, which allow for a principal expansion of said plastics part (b) relative to said core body (a) along the longitudinal axis of the elongated holes.

3. The composite structural article of claim 1 wherein said perforations have a larger dimension in both the x and y directions than both the x and y dimensions of the joining elements extending therethrough.

4. The composite structural article of claim 1 wherein said plastics part (b) forms a rib structure having a plurality of intersecting ribs, said joining elements being located at the intersections of said ribs.

5. The composite structural article of claim 1 wherein the thermoplastics material of said plastics body (b) is selected from at least one of polyamide, polyester, polyolefin, styrene copolymer, polycarbonate, polyphenylene oxide, polyphenylene sulfide, polyimide, PSO and PEEK.

6. The composite structural article of claim 1 wherein said high-strength material of said core body (a) is selected from at least one of fiber-reinforced thermoplastics, thermoset plastics and metals.

7. The composite structural article of claim 1 wherein said joining element is selected from at least one of thermoplastic rivets that are continuous with said plastics part (b), snap fittings and screws.

8. The composite structural article of claim 1 further comprising at least one fixed joining element that provides no reversible frictional movement between said core body and said plastics part along the x and y directions of the plane of each of said core body and said plastics part.

9. The composite structural article of claim 1 wherein said plastics part (b) is formed by injection molding thermoplastic material onto at least a portion of the surface of said core body (a), said joining elements being concurrently formed by means of a portion of the injection molded thermoplastic material extending through at least some of said perforations.

10. The composite structural article of claim 9 wherein, prior to injection molding, removable cores are placed in said perforations, said cores preventing at least a portion of the edges of said perforations from being embedded in the thermoplastic material injected therethrough, said cores being removed after injection molding, thereby resulting in said perforations and said joining elements extending therethrough being mutually dimensioned to allow reversible frictional movement between said core body and said plastics part along one of the x and y direction of the plane of each of said core body and said plastics part.

11. The composite structural article of claim 9 wherein said joining element is a plastic rivet having a rivet shaft and a rivet head, said plastic rivet being continuous with said plastics part (b), said rivet shaft extending through said perforation, and said rivet head forming said interlocking engagement between said core body and said plastics part that is perpendicular to the plane of said core body.

12. The composite structural article of claim 9 further comprising additional joining elements selected from at least one of snap fittings and screws.

13. An article of manufacture comprising the composite structural article of claim 1.

14. The article of manufacture of claim 13 wherein said article of manufacture is selected from motor vehicle components and electronics components.
